(19) United States
(12) Patent Application Publication
(10) Pub. No.: US 2011/0288917 A1
(43) Pub. Date: Nov. 24, 2011

(54) SYSTEMS AND METHODS FOR PROVIDING MOBILE TARGETED ADVERTISEMENTS

(76) Inventors: James Wanek, Highlands Ranch, CO (US); Arif Ayub, Karachi (PK); John Boyd, Ridgefield, CT (US)

(21) Appl. No.: 13/107,352

(22) Filed: May 13, 2011

Related U.S. Application Data
(60) Provisional application No. 61/347,236, filed on May 21, 2010.
(60) Provisional application No. 61/454,619, filed on Mar. 21, 2011.

(51) Int. Cl. G06Q 30/00

(52) U.S. Cl. 705/14.5

(57) ABSTRACT

Methods and systems for displaying advertising or other promotional information to users via mobile devices. In particular, methods and systems that target advertisements using real-time information including location-based, defined geolocation territory rights (e.g., GeoEstate rights) and weather-related information.

### TECHNICAL FIELD

The invention generally relates to improved methods and systems for displaying advertising or other promotional information to users via mobile devices. In particular, the invention relates to methods and systems that target advertisements using real-time information including location-based, defined geolocation territory rights (e.g., GeoEstate rights) and weather-related information.

### BACKGROUND

Several publications are referenced in this application. The cited references describe the state of the art to which this invention pertains and are hereby incorporated by reference, particularly the systems and methods set forth in the detailed description of each reference.

Advertising is a form of communication that typically attempts to persuade potential customers to purchase or to consume more of a particular brand of product or service. Mobile advertising is a form of advertising via mobile (wireless) phones or other mobile devices. As mobile phones outnumber TV sets by over 3 to 1, and PC based internet users by over 4 to 1, and the total laptop and desktop PC population by nearly 5 to 1, advertisers in many markets have recently rushed to mobile advertising.

In some markets, this type of advertising is most commonly seen as a Mobile Web Banner (top of page) or Mobile Web Poster (bottom of page banner), while in others, it is dominated by SMS advertising (which has been estimated at over 90% of mobile marketing revenue worldwide). Other forms include MMS advertising, advertising within mobile games and mobile videos, during mobile TV receipt, full-screen interstices, which appear while a requested item of mobile content or mobile web page is loading up, and audio advertisements that can take the form of a jingle before a voicemail recording, or an audio recording played while interacting with a telephone-based service such as movie ticketing or directory assistance. Other new formats and advertising types are likely in the future.

The emergence of the mobile handset as a display for targeted advertising has piqued the interest of many stakeholders. For example, traditional mobile operators have been reluctant to subject their customers to generic advertisements, but are much more open to pushing targeted advertising, especially when the mobile subscriber has opted-in for such advertising. Internet-based companies such as Google have initiated the Open Handset Alliance as a means (among other things) to participate in ad placement on mobile handsets. Advertisers see the mobile handset as fertile territory. However, mobile subscribers have been very protective of their privacy. For example, directories of mobile numbers do not exist, and have been met with considerable resistance by mobile customers. The personal nature of the mobile phone, coupled with the sensitivity of the general population to such things as identity theft, Internet cookies, GPS tracking services, stalking, etc., have required advertisers and their partners to tread carefully. Given the overwhelming effectiveness of targeted ads vs. banner advertising, there is clear motivation to make targeted advertising acceptable to mobile subscribers by alleviating their privacy concerns while at the same time providing potential value to the subscribers. The features of the method, systems and apparatus of the present invention may be utilized by a variety of telecommunication systems.

The following references describe systems and methods for mobile advertising.
U.S. Pub. No. 2003/0018521 entitled “Advertising Based Upon Events Reported From A GPS Enabled Event Report System” discloses a system to incentivize event reporters to publish information about particular events to be received by others who are within a certain physical location of the event reporter. This publication fails to disclose sharing this information with others who have previously indicated such information would be important to them.
U.S. Pub. No. 2007/0255807 entitled “Social Networking for Mobile Devices” discloses expanding existing social networking systems to mobile communication devices.
U.S. Pub. No. 2008/0040437 entitled “Mobile Social Networking Platform” discloses interconnecting mobile communication devices with instant messaging applications.
U.S. Pub. No. 2007/0268864 entitled “Method and System to Enhance Social Networking Through Random Location Connectivity” discloses a method and system for randomly connecting people based upon where they are physically located.
U.S. Pub. No. 20100088187 entitled “System and method for Localized and/or Topic-Driven Content Distribution for Mobile Devices” discloses a system and method for localized and/or topic-driven content distribution for mobile devices.
U.S. Pub. No. 20100087177 entitled “System and method for providing user-customized mobile advertising service” discloses a system and a method for providing a user-customized mobile advertising service using a piece of event information.
U.S. Pub. No. 20100082972 entitled “Method to allow targeted advertising on mobile phones while maintaining subscriber privacy” relates to advertising on mobile devices.
U.S. Pub. No. 200100115588 entitled “Prevent Unauthorized Subscriber Access Advertisement Service System” generally relates to a mobile advertisement service system, and more particularly to a method, an application server and a system for preventing mobile users to bypass the mobile advertisement service system.
U.S. Pat. No. 7,526,278 by Link et al. entitled “System and method for providing short message targeted advertisements over a wireless communications network” describes a wireless network advertising system that receives requests to transmit advertisement information to certain wireless communications devices that are located within a reasonable proximity to the advertiser.
U.S. Pat. No. 7,657,594 and US 2010008277, each by Banga, et al. and entitled “Directed media based on user preferences” discloses a system for determining directed media for a user (see the exemplary environments of FIGS. 1 and 2, hereby incorporated by reference).
US Patent Publication 20100029300 to Chen entitled “Method for inquiring real-time travel-related information using a mobile communication device” relates to a method for inquiring real-time travel-related information using a mobile communication device having satellite navigation software installed therein.
US Patent Publication 20100070606 to Shenfield et al. entitled “Method and system for mediated access to a data facade on a mobile device” relates to a content delivery system, a mobile subscriber terminal and method for mediated access to a data facade.
US Patent Publication 20100099446 to Panigrahi et al. entitled “Method and node for selecting content for use in a mobile user device”, relates to a method for selecting one of a plurality of contents for use in a “mobile” user device and more particularly for selecting an “advertisement for use in the mobile” user device.
US Patent Publication 20100099441 to Agarwal et al. entitled “Mobile Device Advertising” discloses methods and systems for delivering modified advertisements for mobile devices (including FIG. 1 and accompanying description).
US Patent Publication 20100094710 to Ramakrishna entitled “Method and apparatus to provide information and consumer acceptable advertising via data communications clients”.
US Patent Publication 20100094707 to Freer entitled “Method and platform for voice and location-based services for ‘mobile’ advertising” discloses a platform which enables advertisers to send targeted advertisements to a user of a “mobile” device based on the user's vocal commands at the “mobile” device and the location of the “mobile” device.

### SUMMARY OF THE INVENTION

The invention relates to improved mobile advertisements, promotions, offers announcements or electronic coupons and methods and systems for delivering of the same.

One aspect of the invention relates to improved methods and systems for delivering localized mobile advertisements, promotions, offers announcements or electronic coupons to individuals based on location-based, defined geolocation territory rights (e.g., GeoEstate rights) and/or other defined advertiser rights (e.g., market or time range), and weather-related information.

Another aspect of the invention relates to improved methods and systems for delivering mobile advertisements, promotions, offers, announcement or electronic coupons to an individual based on the advertisers specified GeoEstate property or territorial or other rights.

Another aspect of the invention relates to improved methods and systems for delivering mobile advertisements, promotions, offers, announcements or electronic coupons to an individual based on the individual's location-based information and the individual's activity related information.

Another aspect of the invention relates to improved methods and systems for delivering language and culture specific mobile advertisements, promotions, offers, announcements or electronic coupons to an individual based on the individual's location-based information and the individual's activity related information.

Another aspect of the invention relates to improved methods and systems for delivering mobile advertisements, promotions, offers, announcements or electronic coupons to individuals based on location-based and weather-related information and relative to a given advertiser's location and GeoEstate rights rather than highest bidder.

Another aspect of the invention relates to improved methods and systems for delivering mobile advertisements, promotions, offers announcements or electronic coupons to individuals based on location-based and user acceleration related information.

Another aspect of the invention relates to improved methods and systems for delivering mobile advertisements, promotions, offers announcements or electronic coupons to individuals based on location-based and detected, predicted or estimated user real-time interests or needs.

Yet another aspect of the invention relates to improved methods and systems for delivering mobile advertisements, promotions, offers announcements or electronic coupons to individuals based on location-based information and allowing improved interactions with said individuals including ad choice and selection.

Yet another aspect of the invention relates to improved methods and systems for delivering time-sensitive mobile advertisements, promotions, offers announcements or electronic coupons to individuals based on location-based information.

A still further aspect of the invention relates to methods and systems for allowing advertisers to match or target or create advertisements, promotions or coupons based on specified weather-related or location-related information and/or time sensitive or date sensitive restraints or parameters.

Other aspects as well as embodiments, features and advantages of the present invention will become apparent from a study of the present specification, including the drawings, claims and specific examples.

### BRIEF DESCRIPTION OF THE DRAWINGS

FIG. 1 illustrates a block diagram of a system according to one embodiment of the present invention.

FIG. 2 illustrates a block diagram of the server of FIG. 1.

### DESCRIPTION OF THE INVENTION

One aspect of the invention relates to improved mobile advertisements, promotions, or coupons and methods and systems for creating, delivering and commercializing the same. The features of the method, systems and apparatus of the present invention may be utilized by a variety of telecommunication and/or computer-based systems, including a computer-readable medium having computer-executable components for performing the methods of the invention.

The methods of the invention may be performed using one or more computers in communication with a plurality of clients/mobile device apparatuses and running application software to perform the recited actions. The computing environment should not be interpreted as having any dependency or requirement relating to any one or combination of components illustrated in the exemplary operating environment.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile devices (e.g., cell phones, smart phones, etc.), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

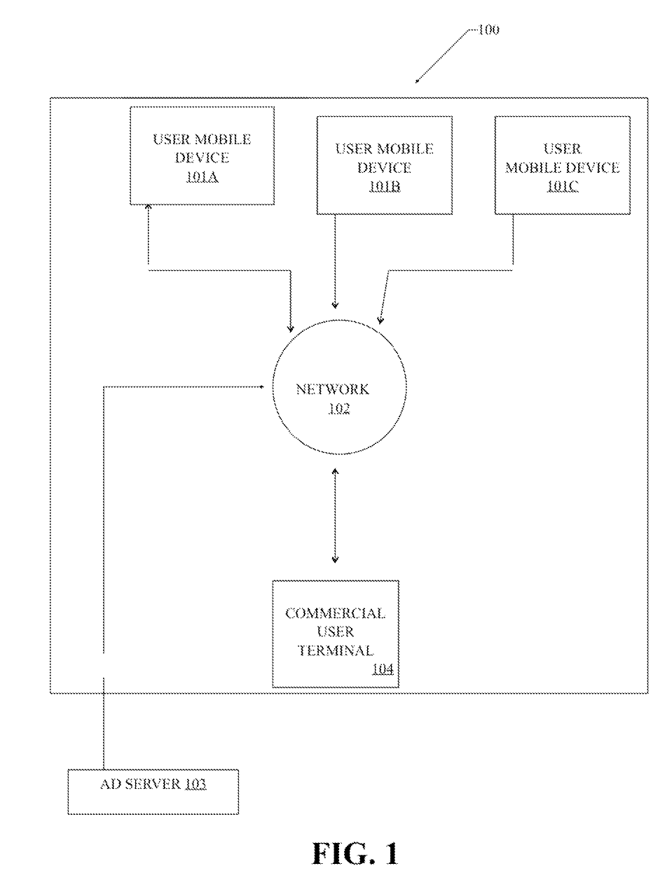

FIG. 1 illustrates a system 100 according to one embodiment of the invention. System 100 includes user mobile devices 101A, 101B, 101C in which the targeted ad methods according to the invention may be executed. A user may receive and, preferably, respond to promotional messages provided on user mobile device 101A which is connected to ad server 103 via network 102 through links, preferably two-way communication links. Server 103 may comprise one or more servers and/or other computer-based systems and there may be additional computer-based systems between mobile devices 101A, 101B, 101C and ad server 103 Network 102 may be any suitable mobile network, preferably a public switched phone network, such as the Internet, an Intranet, LAN or the like. Network 102 may include a standard frame-relay network such as is operated by AT&T, Verizon or Sprint. At various locations, preferably geographically remote from that of ad server 103, a number of intermediate local servers may connect ad server 103 via network 102 to user mobile devices 101A, 101B and 101C. System 100 may preferably further comprise commercial (or vendor or advertiser) user terminal 104 which is also connected to server 103 via network 102. Commercial user terminal 104 may be a commercial user which provides or submits ads, preferably via network 102, to ad server 103 for delivery to the users (e.g., advertisements, coupons, offers, announcements and other promotional items) for products and services. Preferably, ad server 103 tracks the activity or is provided with tracking information to develop optimized targeted advertising and marketing to the users. See, U.S. Pat. No. 6,026,370 to Jermyn; U.S. Pat. No. 5,937,037 to Kamel et al, hereby incorporated by reference. The formats and contents of the information communicated by the systems of the present invention can include ads similar to the types of advertising typically displayed on Web pages via the Internet (U.S. Pat. No. 6,009,410 to LeMole et al.; U.S. Pat. No. 6,009,409 to Adler et al.; U.S. Pat. No. 5,937,392 to Alberts; U.S. Pat. No. 5,959,623 to van Hoff et al.; U.S. Pat. No. 5,913,040 to Rakavy et al.; U.S. Pat. No. 5,933,811 to Angles, et al.; U.S. Pat. No. 5,948,061 to Merriman et al., each hereby incorporated by reference).

Ad server 103 preferably is capable of delivering targeted promotional messages according to the invention to user mobile devices 101A, 101B and 101C and, preferably, receive such messages for delivery from commercial user terminal 104. There are preferably no special requirements for mobile devices 101A, 101B and 101C or commercial user terminal 104, other than that each have some means of assessing the information from server 103, preferably some means of assessing the information or data via network 102. According to an alternate embodiment, specific code or software is downloaded in the mobile devices 101A, 101B and 101C or associated with applications or widgets being used by such devices. Mobile devices 101A, 101B and 101C and commercial user terminal 104 may be structurally the same or different, except devices 101A, 101B and 101C are used by users targeted by the advertisements, whereas commercial user terminal 104 is used by vendors or entities interested in advertising, such as advertising agents, direct markets, product/service providers, etc. System 100 may include any number of user mobile devices or commercial user computers. System 100 may include server 103 or means for conveying information to and from server 103 when server 103 is external to system 100. System 100 may also include (not shown): (i) server 105 for managing publishers merchant credentials and advertiser information and other information and data: (ii) server 106 for managing and providing the geolocation services, information and processes, and/or (iii) server 107 for managing, processing and providing information relating to weather-related information (e.g., weather data server (Yahoo Weather information)). Ads may be served or delivered to mobile applications, mobile websites and/or mobile versions of websites via mobile devices or mobile computers such as laptops or tablets, or even mobile desktops or automobiles equipped with computers. Preferably, ads delivered to computers or other devices resolve location using IP address.

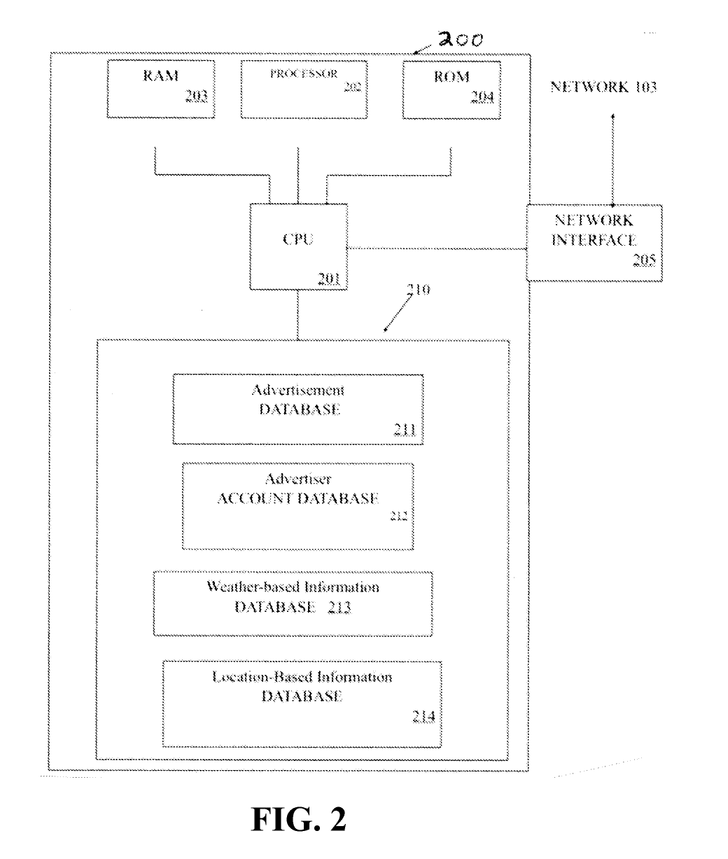

FIG. 2 illustrates a block diagram of ad server 103 of FIG. 1 according to one embodiment of the invention. Server 103 includes CPU 201, processor 202, RAM 203, ROM 204, network interface 205 and data storage device 210. Network interface 205 links server 103 to network 102. CPU 201 is preferably connected to each of the elements of server 103. Server 103 may comprise one or more servers (not shown). CPU 201 executes program instructions stored in RAM 203, ROM 204 and data storage device 210 to perform various functions of the present invention. Ad server 103 may also include or be in communication with 215 publisher database (not shown), 216 payment processing ACI server (not shown) and/or 217 language server (not shown) to process localized content and/or other information or perform other functions.

Data storage device 210 preferably includes a combination of a plurality of databases such as an advertisement database 211, advertiser (or commercial user) account database 212, weather-based information database 213 and location-based information database 214, as well as program instructions (not shown) for CPU 201.

The databases in data storage device 210, such as databases 211, 212, 213 and 214, are preferably implemented as standard relational databases capable of supporting searching and storing multimedia information such as text, audio, graphic, photographs, video, QuickTime movies, etc. Data storage device 210 preferably comprises static memory capable of storing large volumes of data, such as one or more floppy disks, hard disks, CDS, or magnetic tapes.

CPU 201 is also preferably programmed to search databases including databases 211, 212, 213 and 214 and transmit information in response to an ad request or other activity relating to the deliver of advertisements according to the methods of the invention. CPU 201 receives an ad request containing certain criteria (e.g., a search for ads based on location-based and weather-based information) and searches the databases to find one or more matches. Based upon the search, CPU 201 causes the delivery of selected ads to one or more user mobile devices. There are a number of search techniques that can be used including keyword, fuzzy logic and natural language search tools.

CPU 201 is preferably also programmed to receive information or responses from mobile devices 101A, 101B or 101C and transmit such information or responses to the respective advertisers. For example, redemptions, responses, replies, ad forwards, questions/comments, purchases, etc.

CPU 201 preferably comprises a conventional high-speed processor capable of executing program instructions to perform the functions described herein. Although server 103 is described as being implemented with a single CPU 201, in alternative embodiments, server 103 could be implemented with a plurality of processors operating in parallel or in series.

Network interface 205 connects CPU 201 to network 103. Network interface 205 receives data streams from CPU 201 and network 103 formatted according to respective communication protocols. Network interface 205 reformats the data streams appropriately and relays the data streams to network 103 and CPU 201, respectively. Network interface 205 preferably accommodates several different communication protocols.

Cryptographic processor 202 is programmed to encrypt, decrypt and authenticate the stored data in one or more of the databases described above. The mobile user's name, for example, may be encrypted so that commercial users can review the information in the database or receive messages or responses from the users without learning the user's identification. RAM 203 and ROM 204 preferably comprise standard commercially-available integrated circuit chips.

One aspect of the invention relates to improved methods and systems for delivering mobile advertisements, promotions, offers, announcements or electronic coupons to individuals based on location-based and weather-related information.

One embodiment of the invention relates to methods and systems for delivering weather-specific targeted mobile advertisements. Preferably, advertisements that are targeted based on the real-time location of an individual and preferably real-time weather or climate related information. For example, delivering targeted advertisements based on the individual being located in the center of a severe rain storm. Preferably, the targeted advertisements would inform the individual of products or services that would be of interest to the individual such as a place to have coffee or nearby store that is offering umbrellas on sale. Similarly, as another example, the method or system may include delivering a targeted advertisement to an individual determined to be located in area with high humidity and excessively warm temperature whereby the ad may include a coupon for a new soft drink being sold at a nearby convenience store, a promotion for an iced coffee at a nearby coffee shop or an indication of stores or shops in the area selling sunglasses, sunscreen or ball caps.

One advantage of such targeting using specific real-time location-based and weather related activity includes the high probability the ad, promotion or coupon would be of interest to the individual being targeted. Specifically, in contrast to many ads, the individual would appreciate of being informed of a nearby solution for relief to whatever climate condition or other condition the individual is currently experiencing. For example, an individual walking down a NYC street on a 90 degree+high humidity afternoon and receiving a promotion from a nearby coffee shop offering air conditioning, discounted iced coffee and free wi fi is more likely to positively react to such ads. Unlike many ads, such an ad or promotion would likely be welcome by the individual thus increasing conversions and user satisfaction. Another advantage would be for local advertisers being able to better target their ads, promotions, offers, announcements or coupons to individuals at a time and place when the individual is much more likely to positively respond, particularly to nearby customers likely interested in a cold or hot beverage or umbrella depending on the conditions.

Another advantage is the aspect of counter intuitive advertising to promote excess inventory, balance workload throughout the day or promote out of season items. For example, a local golf course could offer a discounted rate on cloudy or light rain days. A restaurant could offer discounts during slow periods throughout the day. Or a local hardware store could offer a special on remaining snow blower inventory in early spring.

Scientific research has proven that weather conditions (temperature, sunlight, wind, rain) at a given time largely determine consumer mood and buying behavior. By incorporating weather related information at a particular location as an additional consideration, an individual can be targeted with weather-specific visual and/or audio advertisements on a mobile device. Websites such as Weather.com and Weather Underground (wunderground.com) have a vast amount of weather information at their disposal and often display targeted advertisements based on the ever changing conditions and forecasts. For example, if it is raining and less than 60 degrees in Portland, then they could trigger a sponsor's banner ad for vacations in Hawaii. If a sponsoring restaurant experiences a downturn in sales when it is raining, then an advertisement for a special promotion is run whenever rain is forecast in the sponsoring restaurant's area. An example case of what Weather.com-like sites currently do: (a) an advertiser indicates would like to target New York City area, (b) Weather.com on its web or mobile site determines the city of the page viewer by IP address-based trace, (c) weather.com based on current weather in the target city serves ads recommending product/service providers across the radius the IP address locks in, and (d) if a page viewer, i.e. a consumer logging on to a site has a registered profile with a zip code, Weather.com tends to apply this parameter as well in conjunction with an IP address to determine the target's likely general location.

However, although some businesses are already targeting consumers with weather-specific ads through web and mobile, such ads are merely targeted based on generic weather information based on a zip code and/or an IP address. The present invention relates to targeting based on the exact location of the consumer viewing an ad and preferably connects the consumer with a nearby vendor. IP-based locking of web and mobile ads, for example, may ensure ad viewers are in a certain city or part of the city, but GPS level precision provides additional advantages, particularly when combined with other location-based information such as nearby vendors, climate and other location-based information.

Moreover, GPS-level precision does not apply to PCs because people do not typically do not move around while using their PCs and most PCs are not equipped with GPS-like functionality. However, when users are mobile and carrying a mobile device, users can be targeted based on where they exactly are, for example, how close they are to a particular coffee outlet or other vendor. Weather-specific targeting on mobile has existed, but exact location of the target is highly advantageous according to the present invention. For example, people cannot be targeted optimally for buying an umbrella from wherever in the city (or IP address determined region, which is generally at least a few miles of radius) when it is raining heavily and they are walking With GPS coordinates (on mobile phones), targeted ads (e.g., banner, video, or audio (e.g., played back)) by umbrella advertisers closest to that exact user point will be shown to the mobile user (via the user's mobile phone or other mobile device) and as a result be of most interest and value to both the advertiser and the individual mobile user. When a user clicks on the ad or further listens to an audio ad, this will be a click through, for which the advertiser will be charged.

Thus, GPS provides substantial advantages compared to existing IP and user-provided zip code parameters allowing the system to determine the exact location of the ad viewer on a mobile phone or other mobile device. And then exact location and weather together provide unique targeting for optimal mobile advertising, preferably determining the individual's specific real time location, specific real time weather conditions and, more preferably, also specifically delivering targeted advertisements from nearby vendors offering goods and services that are preferably of interest to the individual based on the weather-related information. GPS-based targeted ads on mobile already exist, but GPS inter-operating with weather parameter provide much more powerful and relevant targeting. As an example, providers already target an ad “You are at 59^{th} & Broadway in New York City. 9 pm now, and it is time to watch a movie at a theater a few blocks away from you.” According to the invention, the location-based weather parameter is incorporated, which can alter this exact ad entirely—“You are at 59^{th} & Broadway in New York City. 9 pm now, but since it is raining heavily, it is time to get a coffee five steps away from you. Here's a coupon for 25% off your first coffee.” In such conditions, a conversion is much more likely if served an ad of a coffee advertiser, which is within half a minute walk from the exact user point. Suitable methods and systems for displaying coupons include those described in US App 200100094689 to Fodor entitled “Method, System and Graphical User Interface for Coupon or Advertisement Delivery”, hereby incorporated by reference. GPS on a phone determines the exact location of the mobile phone user. GPS is enabled by default on most smart phones available in the market today (iPhone 3GS, for example). According to preferred embodiments, at initiation of a certain action or while the action is in progress (some examples: initiating a sponsored call; downloading an application; watching a free/sponsored mobile video), a hosted advertisement server determines the exact zip code (based on GPS coordinates), makes a web service (HTTP) call to weather data service, and injects a visual or an audio ad based on exact weather conditions at that particular location. The injected advertisement recommends purchases at nearby locations (proximate locations relative to the exact user point determined by GPS). See, for example, the methods and systems for determining location set forth in United States Patent Application No. 200100011081 to Crowley and U.S. Pat. No. 6,664,992 to Fan entitled “Method for distributing location-relevant information using a network”, each hereby incorporated by reference.

Another aspect of the invention relates to improved methods and systems for delivering mobile advertisements, promotions, offers, announcements or electronic coupons to individuals based on location-based and weather-related information and relative to a given advertiser's location, preferably not based on the highest bidder but the closet retail location. That is, preferably, ads are prioritized for delivery to the individual's mobile device based on proximity to the user rather than the bids offered for displaying the ads.

Preferably, each advertiser will specify a given geographic radius from a given retail outlet or other specific location (e.g., defined geolocation territory or “GeoEstate”) to determine the serving area where the ads will be delivered (e.g. Ads will be delivered to users within a 5 mile radius of a given outlet or a specific location such as a concert or other specific event or venue or location). Preferably each GeoEstate (serving area) may also be linked by SIC code, industry or retail outlet type. According to one preferred embodiment, advertisers can register their GeoEstate (serving area) as exclusive, shared exclusive (e.g, co-exclusive) or non-exclusive in the system and pay fees to maintain their serving area for a given category. For example, McDonalds can register an exclusive GeoEstate within a 5 mile radius of a specific restaurant linked to the fast food business category. Or, McDonalds may sign up non-exclusively or share that territory or GeoEstate with one, two or more fast food businesses. Preferably, the advertiser choosing “share” can share with a defined number of others advertisers it will be sharing with. Preferably, the advertiser can choose how many others can “share” and the ad price or rate is adjusted accordingly. For example, the advertiser may select to share with only 1, 2, 3, 4 or more other advertisers.

According to another preferred embodiment, the advertiser may specify a defined market and select exclusive, shared exclusive or non-exclusive for that defined market, and, preferably, select different exclusivity for different defined markets. For example, an advertiser make select exclusive market that is broad (e.g., restaurant) or narrow (e.g., pizza restaurant) and advertise exclusively, shared exclusive, or non-exclusively with respect to both the defined market and defined GeoEstate.

According to another preferred embodiment, the system will display a color coded map to the advertiser of existing exclusive, shared exclusive and non-exclusive serving areas for that defined market. Advertiser can define their custom GeoEstate relative to other advertiser outlets nearby.

Preferably, the advertiser can combine exclusive, shared exclusive or non-exclusive ad campaigns. For example, an advertiser may choose to be exclusive with respect to a first defined GeoEstate (within 1 mile of a specific location) and non-exclusive within a second defined GeoEstate (within 10 miles, but greater than 1 mile from the specific location). As another example, an advertiser may select to be exclusive within a defined GeoEstate for a first defined market (e.g., pizza restaurants), but non-exclusive with respect to such defined GeoEstate for a second defined market (e.g., restaurants).

According to another preferred embodiment, the advertise can define the time or date range for exclusivity, shared exclusive or non-exclusive with respect to a defined GeoEstate and/or market. For example, advertiser (e.g., coffee outlet) may be exclusive in a defined GeoEstate during mornings, but share during other time periods.

According to preferred embodiments, advertisers can choose between exclusive, shared exclusive or non-exclusive rights for associated (i) GeoEstate rights (territory), (ii) market rights and/or (iii) time and/or date range rights, each of (i)-(iii) collectively referred to as “Ad Serving Rights”.

Preferably, according to the methods and systems of the invention, advertisers can create and deliver unique advertisements, coupons or other promotions for specific outlets (e.g., specific vendor locations). Preferably, each advertiser can create and request how the ads will be delivered according to the methods and systems of the invention for two or more individual outlets or allow each outlet to create and/or request ads (e.g., the advertiser delegates control of ad creation and/or delivery to individual or regional outlets). Preferably, such methods and systems allow for the delivering of language and culture specific mobile advertisements, promotions, offers announcements or electronic coupons to an individual, preferably based on the individual's location-based information and the individual's activity related information. For example, if the outlet is in Mexico City, the corresponding ad served will be in Spanish, while ads for an outlet in Warsaw would be served in Polish, etc.

According to one preferred embodiment of the invention, the method or system first checks for the nearest advertiser rather than the one that is the highest bidder, and then checks if the impression or opt-in cost publisher is charging is under or equal to the max cost approved by that nearest advertiser. For example, there is Starbucks as advertiser at 200 meters distance, and Starbucks has approved $0.50 as max cost per opt-in. And then there is another garments store at 320 meters that has approved $0.80 as max per opt-in. If this publisher specifies a rate of $0.60 for opt-in (either during registration or thereafter), and wants to display ads satisfying that criteria, the system will not skip Starbucks and go to the garments store even though the garment store is offering a higher bid. The methods and system are adapted to keep the walking/driving distance to a minimum and hence selects Starbucks as the nearest advertiser despite the lower bid. And then the system determines that $0.60 exceeds the max cost of $0.50 approved by the advertiser. It will not return any ad, and therefore, causing loss of revenue to the publisher. Alternatively, the method or system moves to the next closest ad that is available for display and determines whether proximate to the targeted individual (e.g., within the serving range) and, if so, whether the advertiser meets the publisher's bid requirements. Therefore, publishers are preferably required to keep uniform impression or opt-in costs across advertisers for a particular app—and preferably have them pre-approved. Preferably, the publishers are notified of “missed” ad opportunities resulting from proximate bids not meeting specified threshold so the publisher can adjust. Preferably, on the other hand, if the publisher specifies a rate of $0.45 for opt-in, the lower priced bid of Starbucks would run since closer to the targeted individual. According to one preferred embodiment of the invention, mobile app publishers can manage (e.g., provided with a dashboard to manage) one or many mobile applications or mobile websites as publishing platforms and set preferred/desired rates for multiple ad or offer types and multiple advertisers. Ad or offer types may include a banner ad, a pre app video ad, an interstitial (full banner) or in app video ad or other ad format. Each ad/offer type can be designated with different cost to one or many advertisers. For example, a publisher can set preferred banner CPM at $50 per 1,000 impressions or $125 per 1,000 pre app video ads or offers for each advertiser. According to a preferred embodiment, the system/platform can set charges, fees or costs for one or more options for defined GeoEstates, defined markets and/or defined time ranges based on the exclusive, shared exclusive or non-exclusive as described above for advertisers.

According to one preferred embodiment of the invention, publishers can create ‘house ads’. House ads are specific banner ads, offers, or announcements designed to promote distribution, sales and usage of a given mobile application. Once a house ad is created, a given publisher can search for another mobile applications and mobile web sites registered in the system and request approval from these publishers to serve their house ad on their behalf. For example, publisher A creates a house ad for their mobile application in the system and then selects publisher B to run their house ads. The system automatically notifies publisher B of the request. Publisher B can approve or reject the house ad request. If approved, house ads from Publisher A will be served in Publisher B's app in the absence of a paid ad, offer or announcement.

According to one preferred embodiment of the invention, publishers can register account information form other mobile ad networks. Ads from other ad networks will be returned from the system in the absence of paid ad combined with the absence of a house ad. This will allow the publisher to collect revenue from other ad networks when mobile user is not within a system advertiser GeoEstate and no house ads are available.

According to one preferred embodiment of the invention, the publisher collects 100% of the advertising revenue generated by published ads in their mobile applications or mobile web sites and pays a ‘platform fee’ for the hosted mobile ad platform. Monthly platform fees are established based on usage or total number of ads/offers delivered in a given period of time. According to an alternative embodiment, publishers pay a fee or percentage of revenues received for publishing the ads or for each ad delivered or displayed.

According to one preferred embodiment of the invention, publishers can search for registered advertisers in the system and offer ad inventory along with their preferred/desired rate for each ad type (CPM), GeoEstate, defined market and/or time range. The advertiser is automatically notified and can accept the publisher's offer or negotiate a different rate (e.g., CPM) for a given mobile application. The method or systems allows for negotiation between publishers and advertisers until a suitable rate (e.g., CPM or CPC or other metric) is agreed to by both parties. According to one preferred embodiment of the invention, advertisers can search for registered publishers, ad exchanges, and individual mobile applications or mobile web sites. The advertiser can then view the preferred rate for each ad type in a given mobile application or mobile web site and can either accept the preferred rate (e.g., CPM) or submit an alternate rate for approval by the publisher. The method or system allows for negotiation between advertisers and publishers until a suitable rate (CPM) is agreed to by both parties.

According to one preferred embodiment of the invention, the methods or system allows publishers to store their unique merchant account credentials and collect 100% of the revenue generated by published ads in their mobile applications or mobile web sites. Alternatively, the publishers share a percentage with the ad platform. In addition, the methods or system allows advertisers to store their credit card information. On a periodic basis, the methods or system generates a unique report to both publisher and advertiser for all system activity and automatically processes advertising charges against advertisers' credit card and credits the publishers' merchant account.

According to one preferred embodiment of the invention, advertisers can establish a ceiling for the total cost or advertising in a given application for a specified time period. For example, an advertiser may set a campaign ceiling of $500 in a 60 day period. The advertiser is automatically notified if either they have reached their ceiling or campaign period. For example, if the $500 ceiling is reached in 45 days of a 60 day campaign, the system will automatically notify the advertiser to increase their ceiling or close the campaign. In addition, if a campaign has ended the 60 day time period but total campaign costs are less then $500, the system will notify the advertiser to extend the campaign period or close the campaign.

According to one preferred embodiment of the invention, upon receipt of a request from a mobile application, the method or system first checks for the nearest advertiser (within specified radius of their location) rather than the one that is the highest bidder, and then checks if the mobile user is within an exclusive, non-exclusive or shared exclusive GeoEstate for any advertisers (or other Ad Serving Right). If the user is within an exclusive GeoEstate, the mobile ad is delivered from the advertiser owning the exclusive GeoEstate or other exclusive Ad Serving Right.

For example, Starbucks is the advertiser and there is Starbucks outlet location at 200 meters distance from the mobile user, and Starbucks has agreed to pay $125 per 1,000 ad impressions within a 1,000 meter ‘non-exclusive’ serving area (GeoEstate) of this outlet location. And then there is another coffee shop at 320 meters from the mobile user that has agreed to pay $75 per 1000 ad impressions within a 500 meter ‘exclusive’ serving area of their location. The methods and system are adapted to keep deliver the ad/offer based on proximity to the mobile user and the serving area type (GeoEstate). Therefore, the user will receive the ad/offer from the coffee shop who owns the ‘exclusive’ GeoEstate but NOT closer to the user, and NOT highest bidder.

As another example, there is a McDonalds outlet location as advertiser at 200 meters distance from the mobile user, and McDonalds has agree to pay $25 per 1,000 impressions within a 2,000 meter ‘shared’ serving area (GeoEstate) of this outlet location. Taco Bell is 320 meters from the mobile user that has agreed to pay $35 per 1,000 ad impressions within a 500 meter ‘shared’ serving area (GeoEstate). The methods and system are adapted to keep deliver the ad/offer based on proximity to the mobile user and the serving area type (GeoEstate). Therefore, the mobile users will receive the ad/offer from the McDonalds outlet since it is closer to the user and both GeoEstates are ‘shared’.

According to one preferred embodiment of the invention, advertisers can specify date and time period for each of their mobile campaigns. For example, a restaurant may choose to offer a discount for meals served between 2 PM and 5 PM Mondays thru Fridays.

According to one preferred embodiment of the invention, Advertisers can apply a ‘Promo Code’ (or other identification of a promotional offer) to each of their mobile ad campaigns. The Promo Code preferably is a unique alpha numeric code advertisers create to identify a specific offer or promotion. For example, a sub shop links a promo code DEN1971 for users to receive a free 12 oz drink with the purchase of a submarine sandwich.

According to one preferred embodiment of the invention, the system facilitates promo code redemption by mobile user via SMS (text messaging). When a mobile user accepts a promo code offered by an advertiser and submits their mobile telephone number electronically, the system automatically sends the user AND, preferably, the advertiser a unique redemption code by SMS. When the mobile user arrives at the advertiser's retail outlet, the merchant compares the redemption code presented by the mobile user with the redemption code received by the advertiser via SMS or already known by the merchant (e.g., advertiser agrees to a unique code when starting the campaign and does not need to receive a notification of each new promo code or redemption code generated). After the redemption code is verified by the merchant, the offer or promotion is delivered to the mobile user.

According to one preferred embodiment of the invention, advertisers/merchants can also receive mobile user redemption codes using a mobile application specifically designed for system advertisers. This mobile application will allow advertisers to manage their ad campaigns in real time, update promo codes, and manage redemption codes.

According to the invention, the ad delivery is preferably driven by proximity and GeoEstate ownership type (and/or other Ad Serving Right), and not driven by the highest bidder in contrast to online/mobile ad industry conventions.

According to an alternative embodiment, proximity to the individual is given more weight compared to bid, preferably a 2× weighted preference or higher. According to another preferred embodiment, proximity to an individual may be overridden when an advertiser offers a more attractive offer to the individual (e.g., discount, sale or other promotional offer) relative to the vendor that is closer to better align with the individual's interest. For example, according to one embodiment, an from Vendor A offering a steeper discount may receive priority over an ad from Vendor B even though the individual is closer to Vendor B, if the individual is within the serving area (described below) or other proximity criteria of Vendor A. According to an alternative embodiment, Vendor A will be given priority over Vendor B if Vendor A pays a higher bid so long as the individual is within the serving area or other proximity criteria even without any discount.

The system according to the invention may still utilize zip code because to obtain weather conditions as most third-party weather service APIs require zip code as an input. According to one embodiment of the invention, the user does not provide the zip code but instead the GPS-determined user coordinates are resolved to a zip code, and then weather conditions in the area are obtained from a third-party weather services through its API using the resolved zip code. Proximity based ad delivery is a win-win-win situation for the publisher, advertiser and consumer. Auction based ad delivery systems may result initially in higher revenue but ROI falls over time because the ads are not relevant or targeted to the real-time needs of the end user. In addition, the methods and systems of the invention level the playing field for small retailers. For example a mom and pop frozen yogurt shop can advertise within a 1 mile radius of their store for a fraction of the cost of traditional advertising to reach nearby pedestrians.

Accordingly, one embodiment of the invention relates to methods and systems for delivering targeted mobile advertisements based on weather-specific information, location based information and GeoEstate ownership (or other Ad Serving Right ownership), preferably with GPS-level precision. Preferably, the location based information is used to both determine specific weather or climate related information and also provide the individual with a targeted advertisement for proximate services or products from nearby vendors based on GeoEstate ownership that would interest the individual, preferably related to product or services likely to be of more interest to the individual because of the weather. One embodiment relates to weather related warnings or similar broadcasts and the targeted ads are for relevant items of interest (e.g., flashlights, batteries, water, and other supplies) for specific predicted upcoming weather conditions (e.g., severe thunderstorm, heavy winds, hurricane, ice storm) offered by vendors nearby the individual. Preferably, such weather conditions can be real-time, predicted in the future for the individual's current real-time location or predicted future location (e.g., home zip code vs work). For example, an ad might be displayed to an individual “Ice storm and power outages predicted in your city. Pick up some batteries and flashlights on way home!”

Preferably, the system can predict the individual's future location based on prior history or other means. Such a service provides value to vendors offering such supplies, but also enhanced safety for individuals being provided with a reminder to pick up critical supplies with an indication where can do so.

Another embodiment of the invention relates to methods and systems for delivering weather-specific targeted mobile advertisements. Preferably, advertisements that are targeted based on the real-time location of an individual and weather or climate related information.

Another embodiment of the invention relates to a method or system for transmitting a message (e.g., advertisement, coupon or other promotion) over a wireless network to a wireless communications device, the method comprising: storing a plurality of messages in a database, wherein each stored message is associated with one or more locations and weather-related information, the plurality of messages stored in the database including advertising information sponsored by a respective advertiser having a place of business within a proximity of the location associated with the message; detecting location information of a wireless communications device and weather-related information relating to detected location information; selecting a message in the database associated with the detected location (Ad serving area), weather-related information and GeoEstate and/or other Ad Serving Right ownership; and transmitting the message to the wireless communications device. Preferably, the method further includes receiving an acknowledgement from the wireless communications device of receipt of the transmitted message; and storing a confirmation of the transmitted message in an account associated with the respective advertiser sponsoring the message. According to a further preferred embodiment, the message selection is also based on an individual's activity-related information (e.g., walking or driving). According to a further preferred embodiment, the message selection is targeted based on the product or service being offered in the message predicted to be of increased interest to the individual using the wireless communication device (e.g., Smartphone) based on the weather-related information. Preferably, one or more of the messages stored in the database is also associated with one or more demographic codes, and more preferably one or more wireless communications device operating in the wireless network is associated with one more demographic codes, and wherein the message selected to be transmitted is associated with at least one demographic code associated with the identified wireless communications device in addition to being associated with the detected location. According to a particularly preferred embodiment, the method further includes receiving a response from the wireless communications device; and providing notification of the response to the advertiser sponsoring the transmitted advertisement. Preferably, one or more messages are associated with at least one category code, e.g., indicating the user's preferences in receiving messages, time period preferences for ad delivery, or other preference.

Another embodiment of the invention relates to a computer-based method for delivering weather-specific location-based targeted ads, coupons, offers, announcements or promotions to mobile devices comprising:

receiving by a server a request from a mobile device, or from a computer-based system in communication with said device, for one or more advertisements to be displayed on said mobile device;
determining whether one or more rules associated with delivering advertisements apply to the request;
processing the request if all rules determined to be applicable are satisfied; and
denying the request if one or more rules determined to be applicable are not satisfied;
wherein: said method further comprises delivering said advertisement to said weather-specific location-based mobile device.

Preferably the computer-based method uses one or more computer-based systems in addition to said mobile device to deliver and display said ads, coupons or promotions to said mobile devices. Yet another embodiment of the invention relates to a method for transmitting a message (ad, promotion or coupon) over a wireless network to a wireless communications device, the method comprising: storing a plurality of messages in a database, wherein each stored message is associated with one or more locations and one or more weather-related criteria, one or more GeoEstate and/or other Ad Service Right ownership levels, the plurality of messages stored in the database including advertising information sponsored by a respective advertiser having a place of business within the proximity of the location associated with the message; detecting location information of a wireless communications device; detecting GeoEstate ownership rights; selecting a message in the database associated with the detected location; ad transmitting the message to the wireless communications device, wherein said message is selected for said transmitting using location-based information detected by or otherwise provided by said wireless communication device and weather-related information relating said location.

Preferably, the method further comprises receiving an acknowledgement from the wireless communications device of receipt of the transmitted message; and storing a confirmation of the transmitted message in an account associated with the respective advertiser sponsoring the message.

Yet another embodiment relates to a computer readable medium storing computer executable instructions that, if executed by a computer, cause the computer to perform the methods of the invention. Another embodiment relates to a system comprising one or more computers and including said computer readable medium.

Yet another embodiment relates to computer-based system for delivering the targeted ads of the invention, the system comprising: a user interface for interacting with a first user; a network connection; a persistent storage; a memory for storing software instructions; and a processor operatively connected to the memory, the processor for executing the software instructions; wherein the software instructions enable the processor to: receive information relating to one or more targeted advertisement requests for delivery to one or more mobile devices; retrieve one or more targeted ads from the persistent storage selected based on the methods of the invention; and transmit said targeted ads to said mobile devices. The method can also be implemented as machine executable instructions executed by a programmable information processing system or as hard coded logic in a specialized computing apparatus such as an application-specific integrated circuit (ASIC).

Another embodiment of the invention relates to a computer system, and to a computer-readable medium containing instructions for controlling the computing system, for providing location-based advertisements to mobile devices, comprising: an aggregation component that collects advertisements one or more advertisement sources, extracts data from the collected advertisements, and stores the extracted data of the advertisements in a common format; a transformation component that transforms the extracted data of an advertisement into multiple advertisement formats that are specific to device types; and a search component that identifies advertisements that match a location-based ad request associated with said mobile devices, ranks the advertisements based on a location associated with the advertisements, and selects advertisement formats for the advertisements based on location based information, weather-related information and GeoEstate ownership. Preferably, said advertisements are also selected based on the device type of the mobile device. Suitable related methods and systems for use in the invention are described in U.S. Pat. No. 7,650,431 by Lee entitled “Servicing Locally Relevant Advertisements”, hereby incorporated by reference (specifically the methods and systems described in the detailed description, including FIGS. 1-9). Preferably, the advertisements, promotions or electronic coupons are delivered to individuals based on location-based and weather-related information and relative to a given advertiser's location rather than highest bidder.

Preferably, the aggregation component extracts business name, business location, keywords, and business category for the advertisements, along with target weather-related information. Target weather-related information may weather codes, such as: tornado, tropical storm, hurricane, severe thunderstorms, thunderstorms, mixed rain and snow, mixed rain and sleet, mixed snow and sleet, freezing drizzle, drizzle, freezing rain, showers, showers, snow flurries, light snow showers, blowing snow, snow, hail, sleet, dust, foggy, haze, smoky, blustery, windy, cold, cloudy, mostly cloudy (night), mostly cloudy (day), partly cloudy (night), partly cloudy (day), clear (night), sunny, fair (night), fair (day), mixed rain and hail, hot, isolated thunderstorms, scattered thunderstorms, scattered thunderstorms, scattered showers, heavy snow, scattered snow showers, heavy snow, partly cloudy, thundershowers, snow showers, and/or isolated thundershowers (e.g., http://developer.yahoo.com/weather/). METAR or similar weather related codes may also be used. Weather-related information may also include humidity, temperature, barometric pressure, predictiveness of the weather-related information (e.g., whether the conditions were anticipated), changes in weather conditions and ranges of weather conditions. Preferably, a subset of weather codes may be used.

The computing device on which the advertisement system is implemented may include a central processing unit, memory, input devices (e.g., keyboard and pointing devices), output devices (e.g., display devices), and storage devices (e.g., disk drives). The memory and storage devices are computer-readable media (with each memory and storage device being a computer-readable medium) that may contain instructions that implement the advertisement system. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the advertisement system may be implemented in various operating environments that include personal computers, server computers, hand-held or laptop devices, mobile devices, multiprocessor systems, microprocessor-based systems, programmable consumer electronics, digital cameras, network PCs, minicomputers, mainframe computers, distributed computing environments that include any of the above systems or devices, and so on. The computing devices that interact with the advertisement system may be cell phones, personal digital assistants, smart phones, personal computers, programmable consumer electronics, digital cameras, and so on, preferably smart phones, cell phones, and other mobile devices.

The advertisement system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, the advertisement system may be implemented on a computer system separate from the map service, the navigation service, location-based service (e.g., GPS), weather-related service or other services for which it provides advertisements.

Preferably in addition to weather filters or codes, the system allows advertisers to target ads also using temperature range and season filters or other weather-related information or warnings. By default. preferably all four seasons are selected for any ad being created. Preferably, an advertiser can choose to run an ad for just the current season, and the campaign automatically coming to a halt when stepping into another season that is not selected. For example, going from Winter to Spring and then resuming again in the Summer (if selected).

Preferably, the GPS or equivalent location of the device is determined, and more preferably, the speed, acceleration or other activity-related information relating to the individual being targeted by the advertisement, promotion or coupon.

Preferably, advertisements from vendors closer to the mobile device with exclusive GeoEstate rights are ranked higher than other advertisements for delivery to the mobile device. Preferably, advertisements with improved matching of the weather-related ad parameters are ranked higher than those with lower matching.

In one embodiment, an advertisement system aggregates advertisements by collecting advertisements from multiple advertisement sources. For example, the advertisement system may collect advertisements from pay-for-click advertisement systems, advertisements from electronic Yellow Pages, advertisements generated from electronic business listings and/or advertisements from another source (e.g., pay per view, pay per lead/conversion). The advertisement system preferably extracts data from the collected advertisements and stores the extracted data in a common format. For example, the advertisement system may extract data that includes business name, business location, keywords, and business category.

In the absence of a paid ad or offer, the system will deliver a ‘House Ad’ to the mobile users. House Ads are promotions for other publishers apps registered in the system. For example, publisher A creates a house ad and submits his ad to publisher B for approval. If publisher B approves the house ad for Publisher A then the house ad for publisher B is served if no paid ad is present in the system when a mobile user requests an ad from the publisher B application.

The advertisement system also identifies the GeoEstate or the “serving areas” (or other Ad Serving Rights) of the advertisements. The GeoEstate (serving area) represents the geographic area from which the business being advertised desires to draw customers. For example, the GeoEstate of an advertisement for a coffee outlet may have a three-block radius centered at the coffee outlet while the GeoEstate for a car dealership may have a 50-mile radius. “GeoEstate” for any particular business may also very depending on the activities of the user (e.g., walking, driving, etc.). Preferably, any designated “GeoEstate” for a vendor promotion, ad or coupon, includes a variations depending on the target user activity. The advertisement system may determine the serving area in various ways, such as from explicit metadata associated with advertisements or analyzing the content of the advertisements. Preferably, when the advertisement system receives queries for advertisements, it searches for advertisements that match the query. A query may be submitted by a user of a device to a content service (e.g., map service) to search for content or a request from the device (e.g., from an application seeking to retrieve one or more ads to publish on the mobile device). The content service may in turn submit that query to the advertisement system to identify advertisements that match the query. After identifying matching advertisements as candidate advertisements, the advertisement system ranks the candidate advertisements based on a location associated with a query and a location associated with the advertisement and any other matching criteria (e.g., weather, mode of transportation, etc.). The location associated with the query may be the user's current location represented by the location of the device or a query location derived from the query itself. For example, the advertisement system may rank the advertisements whose GeoEstate encompass the user's current location or query location higher than those that do not. Preferably, advertisers who own ‘exclusive’ GeoEstate rights will be ranked highest followed by ‘non-exclusive’ GeoEstate rights. Advertisers with ‘shared exclusive’ GeoEstate rights receive preference over non-exclusive rights, which receive no preference. The advertisement system then selects an advertisement format that is appropriate for the requesting device for each of the highly ranked advertisements and provides those advertisements in response to the request for advertisements. In one preferred embodiment, the advertisement system selects targeted advertisements to display to a user based on the serving area of the advertisements. An example system for selecting advertisements based on serving area is described in U.S. application Ser. No. 11/467,810 filed on Aug. 28, 2006, entitled “Selecting Advertisements Based on Serving Area and Map Area” and U.S. Pat. No. 7,650,431 by Lee entitled “Servicing Locally Relevant Advertisements”, each hereby incorporated by reference.

Another aspect of the invention relates to improved methods and systems for delivering mobile advertisements, promotions, offers announcements or electronic coupons to individuals based on location-based, advertiser GeoEstate rights, and detected, predicted or estimated user real-time interests or needs, preferably using weather-related or other information (e.g., predicted severe weather).

According to one preferred embodiment of the invention, the method includes obtaining weather conditions at the exact mobile phone user location in real-time (on GPS-enabled mobile devices) and providing or delivering from a hosted advertisement server weather-specific advertisements preferably through a mobile application (native or mobile browser-based application), preferably recommending most proximate locations for buying good based on the GeoEstate rights for a given location and services (goods and services specific to the weather) or providing coupons or promotional information from nearby vendors.

Preferably, the method or system determines whether the whether condition was predicted. For example, a user caught in an unexpected rain storm may be more interested in nearby umbrella sales compared to someone in an expected rain storm. Accordingly, whether the current weather was predicted or not is determined when selecting and delivering an ad since the predicted nature of the weather likely impacts the effectiveness of certain ads. According to one preferred embodiment, the methods and systems determine whether the local weather or climate conditions were predicted and target the ad based on location, weather and whether the weather was predicted by the weather services. The determination of whether the current real-time weather was predicted preferably includes accessing an archived database of weather information and comparing to real-time weather.

Preferably, the method or system determines the time of day and targets the advertisements based on that additional factor. For example, an ad delivered to a pedestrian walking in the cold may be different in the morning (e.g., hot coffee) vs lunchtime/afternoon (e.g., hot soup or other hot meal).

Preferably, the methods and systems further determine the mode of transportation of the individual and targets ads based on the individual activity mode (e.g., walking, driving, riding a bike, on a train, or bus, etc.). Preferably, this is detected or determined based on information provided by an accelerometer or similar device functionality provided by the mobile device. For example, an individual identified as driving in a car would not be limited to promotions or ads for services within reasonable walking distance and might be more interested in food or drink vendors within driving distance or with drive-by windows. In contrast, an individual walking would be more likely to act on an ad or promotion for a nearby local product or service vendor compared to someone driving by in a car. According to one preferred embodiment, detected or determined activity mode of the individuals is matched with or generates an advertisement, coupon or promotion having a designated servicing area adjusted for said activity mode. U.S. Pat. No. 7,536,190 by Creemer entitled “Providing content based on user-specific information from a wireless device”, hereby incorporated by reference, discloses targeting services according to information derived from a wireless devices comprising accessing the rate of travel, the direction of travel and providing content based on the user-specific information, the rate of travel and direction of travel, and optionally other information can be factored into the selection of the appropriate content or service, for example, weather conditions, time of day, and the like can be considered to further refine the selection of the appropriate content or service. In contrast, the method and systems of the invention delivers target advertisements based on specific GPS-like location-based information and specific weather-related information, preferably also based on an individual's activity, the proximity of the vendor's advertising and the other targeting factors described in the present application. Preferably, the ads according to the invention are selected based on vendor proximity to the individual being targeted, rather than highest bid, as described above.

Another aspect of the invention relates to improved methods and systems for delivering mobile advertisements, promotions, offers announcements or electronic coupons to individuals based on location-based and the individual activity related information. One embodiment involves determining the speed or activity of the user when selecting the targeted ad. For example, an ad targeted to based on rain information may be delivered to an individual determined to be walking vs. an individual detected to be running or riding a bike. Thus, another aspect of the invention relates to improved methods and systems for delivering mobile advertisements, promotions, offers announcements or electronic coupons to individuals based on location-based and user acceleration related information, and preferably weather related information.

Another aspect of the invention relates to improved methods and systems for delivering language and culture specific mobile advertisements, promotions, offers announcements or electronic coupons to an individual based on the individual's location-based information and the individual's activity related information. Preferably, according to the methods and systems of the invention, advertisers can create and deliver unique advertisements, coupons or other promotions for specific outlets (e.g., specific vendor locations). Preferably, advertisers can create and request how the ads are delivered for two or more individual outlets or allow each outlet to create and/or request ads (e.g., the advertiser delegates control of ad creation and/or delivery to individual outlets or regional outlets). Preferably, such methods and systems allow for the delivering of language and culture specific mobile advertisements, promotions, offers announcements or electronic coupons to an individual, preferably based on the individual's location-based information and the individual's activity related information. For example, if the outlet is in Mexico City, the corresponding ad served will be in Spanish, while ads for an outlet in Warsaw would be served in Polish, etc.

Yet another aspect of the invention relates to improved methods and systems for delivering time-sensitive mobile advertisements, promotions, offers announcements or electronic coupons to individuals based on location-based information. Preferable, the ad, promotion or coupon is provided with an indication of the time period the offer or promotion is available or other time constraint. Preferably, the time period or other time constraint is set by the advertiser and/or otherwise associated with the advertisement. For example, an ad may be provided with a code that the promotion or offer in the ad must be used within a specified period of time (e.g., within 5 minutes). One preferred embodiment would relate to food or drink vendors that have products available at a discounted rate for a limited period of time. One example could be a coffee shop that produces an incorrect order for a first customer and requests the delivery of promotional ads to nearby individuals indicating the incorrectly made coffee is available at a discounted rate, preferably, first come first serve. According to one preferred embodiment, the individuals receiving the ad or promotion can select “accept” or a related action to indicate a desire to purchase the discounted item. As another example, many food vendors need to discard items unsold after a period of time. The aspect of the invention would match food or drink vendors desiring to sell items at a discounted rate within a limited period of with individuals in the nearby area. See, for example, the method and systems set forth in U.S. Pat. No. 6,741,969 entitled “System and method for reducing excess capacity for restaurants and other industries during off-peak or other times”, U.S. Pat. No. 7,184,990 to Walker et al. entitled “Method and apparatus for selling an aging food product”, and U.S. Pat. No. 7,657,463 to Shaw, et al. entitled “Systems and methods for delivering item price notifications to a mobile device”, each hereby incorporated by reference.

As described in U.S. Pat. No. 7,184,990 to Walker, quick service restaurants are restaurants that specialize in rapidly selling food that is typically ordered only a few minutes before it is tendered to the customer. Many quick service restaurants will sell food products for some time after those food products have been prepared. For example, hamburgers may be available for sale up to twenty minutes after being cooked. Food products that are excessively aged become “perished” (e.g. stale or soggy). Selling such perished food products would hurt the reputation of the restaurant. Furthermore, aged food products can pose a significant health risk to consumers, which in turn would impose liability on the restaurant. Accordingly, if the food product is not sold within a certain time period after being prepared it is typically thrown away. This waste is considered a cost of doing business and factored into the restaurant's expenses. Walker describes an automated kitchen apparatus determines a time until expiration of a food product. In one embodiment, the kitchen apparatus determines the time until expiration by receiving a start signal indicating that a food product is available to sell. Such a start signal may be generated by a timer on a warming bin that is initiated when a food product is placed in the warming bin. By measuring the elapsed time since the start signal was received, the time until expiration is determined. Based on the time until expiration, the automated kitchen apparatus sets the minimum price of that food product. Customers at a POS terminal may then purchase the aged food product for the minimum price, or in another embodiment for an amount that is greater than the minimum price. In one embodiment, an offer describing the food product and its minimum price is displayed on the POS terminal. In another embodiment, the customer is offered the food product for his change due, if that change due is not less than the minimum price. According to this aspect of the invention, restaurants and other food and beverage vendors may be further provided with access to the method and system of the invention, allowing the vendor to broadcast the discounted product to nearby individuals, preferably with an associated time constraint, discount and other information.

According to another embodiment, the vendor may select to send or transmit promotions for discounted or free or some other promotional offer to nearby individuals who have registered on the vendors' website or application or have taken some other required action. Preferably, the vendor can broadcast offers for free product (e.g., free coffee) for nearby individuals who are “members” of the vendors Facebook page or group (or other social network or social media platform), Twitter follower, Gowalla/Foursquare frequent checkin, registered on the vendors site, etc. That is, preferably, the vendor or advertiser can control the types of individuals receiving the promotion.

According to another embodiment, the promotion may indicate a limited number of products that are available and preferably also designate as “first come, first serve” and/or a requirement that an individual accept the offer and agree to purchase the item within a limited amount of time or set up a bidding whereby individuals can bid for the available product. For example, a fast food vendor may indicate there are six burgers available for a limited amount of time at a discounted rate since the vendor will have to soon discard to keep within its quality guidelines. The invention reduces waste, provides the vendor with additional revenue that would otherwise be lost and offers the product to nearby individual at a discount.

According to another embodiment, the vendor may select to send or transmit promotions for discounted or free or some other promotional offer only to nearby individuals who have registered on the vendors' website or application or have taken some other required registration or membership action. Alternatively, the vendor may select to send the notifications to members before sending to nonmembers. Preferably, the vendor can broadcast offers for free product (e.g., free coffee) for nearby individuals who are “members” of the vendor's Facebook page or other social networking service, register on the vendor's site, fill out informational cards at the vendor's outlets, etc. That is, preferably, the vendor or advertiser can control the types of individuals receiving the promotion and, preferably, specifically target loyal or repeat customers or the vendor's “friends” with the vendor's free or discounted offers.

For example, a fast food company may run a campaign to get customers to sign up on its website or join its social networking page or fill out a card providing the necessary information (e.g., the information needed to send the people notifications about discounted or free food at nearby franchises). When a vendor has items it wishes to advertise for free or discounted prices, the method or system delivers the ads to nearby registered members. Preferably, focusing on nearby “registered members”. According to one embodiment, the registered members get the notifications before unregistered individuals (e.g., 5 minutes, 10 minutes, 15 minutes, etc. before unregistered individuals, as selected by the advertiser).

Preferably, the method and systems of the invention allow advertisers to associate links, widgets or other functionality to allow individuals to “register” or “sign up” with the advertiser. For example, the advertiser's ads or promotions include a “Join us on Facebook” link to associate the individual with loyalty programs and facilitate individuals signing up to get preference on free or discounted items.

According to another preferred embodiment, the system or method provides a simplified user interface for an individual (e.g., owner or employee of a fast food restaurant or coffee shop) to submit time-sensitive advertisements or promotions for delivery to nearby mobile users. Preferably, the interface is accessible via a point of sale terminal (see FIG. 1 of Walker, hereby incorporated by reference) or via a terminal located within the kitchen or other vendor location or via computer-based device (e.g., laptop, smart phone, iPhone, etc.) with online access. Preferably, the vendor is allowed to register for an account, provide vendor information, upload templates for mobile ads (e.g., one with a picture of a burger, another of fries) and/or set bids for ads.

Preferably, the interface includes set preferences and a template or interface for creating and submitting ads for delivery. Set Preferences may include submitting a list of items typically offered for sale (e.g., item names or other identification, preferably allowing for different sets, e.g., for breakfast, lunch, dinner, etc.), regular price, preferred graphics to use in the ad (e.g., uploaded ad graphics), and other information a vendor may wish to upload or input. Preferably, the template or interface for generating and requesting the delivery of mobile ads allows the owner or employee to indicate the item(s) being offered, the quantity available, the time period the item(s) will be available, the “serving area” of the broadcast (e.g., how far away can the targeted individuals be), pricing information and any action required by the targeted individuals (e.g., first come first serve, a requirement to respond to the promotion, etc.). Preferably, pricing information may include the regular price, the discounted price, the percent discount or related pricing information. Preferably, the offer (e.g., price) may change over time. For example, the offer may start an initial price but proceed to drop as the product reaches its expiration. Preferably, the system and method further provides for functionality to allow the vendor to “notify” the targeted individuals, or selected individuals (e.g., those who indicated an interest), that the promotion has been cancelled, withdrawn or filled. Preferably, the system and method allows for receiving responses or questions from individuals interested in the offer.

Another aspect of the invention relates to improved methods and systems for delivering mobile advertisements, promotions, offers announcements or electronic coupons to individuals based on location-based information and allowing improved interactions with said individuals including ad choice and selection. US Patent Pub. 2001000114717 entitled “Secondary content Delivery System”, hereby incorporated by reference, describes methods and systems of secondary advertisements which can enable users receiving an initial advertisement to respond to the initial advertisement to request secondary content or supplemental content. In some implementations, the response can include an indication of a device identification associated with the user. In some implementations, an advertising server can provide secondary content including a messaging based advertisement to the user based upon receiving a response to the initial advertisement from the user. In various implementations, the messaging based advertisement can be a format conversion of the initial advertisement, or a completely separate messaging based advertisement created by an advertiser. While reference is made to advertisements, other forms of content can be delivered including other forms of sponsored content. Further, while reference is made to a messaging system and delivery of an advertisement by way of a messaging systems, other forms of distribution are possible.

According to preferred embodiments of the invention, an individual is provided with a first location-based targeted ad and is provided with the option to: (a) “snooze” or “show me later”, thereby requesting the ad to be shown again at a later time, (b) “save” the ad thereby saving the ad for later reference or use or (c) “request another” to request to see the next relevant ad. For example, an individual may be provided with an ad promoting a new coffee product and free internet access at a nearby coffee shop, but the individual may discover the shop is full and may request the next closest coffee shop and so on. Or, the individual might want to travel a further distance to make another stop before acting on the ad or promotion and wish to find a vendor proximate that other stop or location. See, for example, the methods and system for facilitating user requests set forth in US 20100100449 to Broberg et. al., hereby incorporated by reference, which discloses method and system of advertising that facilitates an automated advertisement process where a user, at any point during playback, simply makes a request to view an advertisement and an advertisement related to the current point of playback is automatically provided. The advertisement can be related to a scene showing proximate in time to the request so that the user can specify what type of advertisement is provided and when it is provided. Preferably, users are provided with incentives to receive, view and/or react positively to an ad (e.g., see U.S. Pat. No. 7,660,737 to Lim et al., hereby incorporated by reference). User receipt and activity relating to delivered ads may also be tracked. See US App 20100100445 by Flood et al., entitled “System and method for targeting the delivery of inventoried content over mobile networks to uniquely identified users”, hereby incorporated by reference (specifically FIGS. 1 and 3 and the methods and systems described therein).

Preferably, the ad recipient is able to forward the ad, coupon or promotion to a friend, preferably also being allowed to add a note. Preferably, the system or method further informs the recipient of nearby friends or contacts who may be interested in the local promotion and, preferably, is allowed to select nearby friends to send the promotion to, preferably with a note for the friend. Another aspect of the invention relates to methods and system of the invention and further allowing individuals to set their individual preferences for receiving ads, coupons and promotions. Preferably, a user interface is provided for individuals to set up an account. Preferably, an individual can request to be notified of specific types of ads, promotions or coupons, preferably even if outside the “serving area” or location-based information associated with an ad. For example, an individual may wish to receive any promotion or offer relating to a particular coffee offer within a 1 mile radius of the individual's real-time location and thereby receive ads that might have been targeted to individuals within ½ mile. Although this functionality may override the express ad delivery criteria set by the advertiser, the result will be an ad delivered to an individual self-identified as being interested in the specific product or service offered in the ad, promotion or coupon. Preferably, the individual can also set preferences regarding the types of ads interested in receiving and those not wishing to receive and, preferably also being able to turn on and turn off the delivery of ads to the individual's device.

Another aspect of the invention relates to methods and systems for allowing advertisers to match or target advertisements based on specified weather and location information.

“Inventoried content” refers to components of multimedia content that may be requested by network-based publishers and incorporated into larger works or in ads displayed on mobile communication devices; the access and display of such inventoried content may be tracked in order to perform related accounting functions. Advertisements are an example of inventoried content that may be incorporated by network-based publishers into larger works that are rendered on end users' mobile devices, “mobile’ phones, or personal digital assistants. An inventoried content delivery service (ICDS) refers to an entity or service organized to maintain an inventory of content received from advertisers and deliver such advertisements to publishers for display to end users. According to the invention, inventoried content in the form of advertisements, coupons, or other promotions can be delivered to one or more individuals.

Another aspect of the invention relates to methods and systems of optimizing the targeting of ads, coupons or other promotions based on location-based information, GeoEstate rights (and/or other Ad Serving Rights), and weather-based information, and, preferably, other factors or information described in the present invention for targeting. According to one embodiment, the method and system determines the conversion rate of ads based on: (a) vendor proximity to user; (b) vendor GeoEstate rights, (c) weather-related information; and preferably, one or more of: (i) product or service promoted; (ii) discounting or other promotional information; (iii) time of day, (iv) day of week or month; (v) time of year; (vi) user activity; (vii) type of ad format (e.g., text, video, audio), (viii) level of prediction for real-time weather condition; (ix) user demographics; and other factors. For example, see U.S. Pat. No. 7,650,431, US 20100100615 to Lee, and US 200100082775 to Banga et al, hereby incorporated by reference, for methods and systems for extracting data associated with ads and/or ad optimization, or any of the methods and systems for optimizing ads disclosed in the patents and patent application cited in the present application, hereby incorporated by reference.

One embodiment of the invention relates to method involving Mobile App Providers (Publishers) and Advertisers. According to preferred embodiments of the invention, the ‘ad serving’ API is open-standards HTTP API making it device independent (e.g., works whether it is an iPhone, iPad, iPod Touch, Blackberry, Android, Windows Smartphone, Symbian or any other GPS-enabled handheld, the ad system integrates in a uniform way). Preferably, the method and system may be integrated by a mobile developer for use with the developers application, widget, or website.

According to another preferred embodiment, all advertisers must have physical outlet or outlets (i.e., there is no purely virtual company campaigns that can be run through the system). Physical outlet could be a single retail store or a large chain such as Starbucks. Preferably, when an advertiser creates an ad, it must apply the weather filters (e.g., the weather conditions provided by Yahoo! Are grouped into about 10 or those discussed above). Preferably, the ads according to the invention include a promo code or discount coupon or redemption code tied to it. Mobile users can view an ad and complete a form to send their name and mobile telephone number tot the system. The system generates a unique redemption code based on the give promotion. This unique redemption code is then sent to the mobile user AND the advertiser outlet location by SMS. When that redemption code is displayed by the mobile at the retail outlet, the redemption code is then used by the advertiser/outlet to track a conversion using the system of the invention. The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

With respect to the appended claims, unless stated otherwise, the term “first” does not, by itself, require that there also be a “second”. While the particular methods, devices and systems described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention.

1. A method for delivering a message to a mobile device, comprising selecting one or more messages targeted based on location-based, advertiser GeoEstate rights and weather-related information relating to said mobile device's location.

2. The method of claim 1, wherein said message comprises one or more advertisements, promotions or electronic coupons.

3. The method of claim 1, wherein said message relates to a vendor or a product or service offered by the vendor.

4. The method of claim 3, wherein said message is prioritized for delivery based on said vendor's proximity to the mobile device and advertiser GeoEstate rights.

5. The method of claim 3, wherein said message is prioritized for delivery based on said vendor's proximity to the mobile device and advertiser GeoEstate rights rather then the highest bid for delivering the message.

6. The method of claim 1, wherein said location-based and weather-related information is real-time information detected based on the location of said mobile device.

7. A method for transmitting a message over a wireless network to a wireless communications device, the method comprising: storing a plurality of messages in a database, wherein each stored message is associated with one or more locations linked with unique GeoEstate rights and weather-related information, the plurality of messages stored in the database including advertising information sponsored by a respective advertiser having a place of business within a proximity of the location associated with the message; detecting location information of a wireless communications device and weather-related information relating to detected location information; selecting a message in the database associated with the detected location and weather-related information and transmitting the message to the wireless communications device.

8. The method of claim 7, further includes receiving an acknowledgement from the wireless communications device of receipt of the transmitted message and storing a confirmation of the transmitted message in an account associated with the respective advertiser sponsoring the message.

9. The method of claim 7, wherein said message selection is also based on an individual's activity-related information.

10. The method of claim 7, wherein said message selection is targeted based on a product or service being offered, advertised or promoted in the message predicted to be of increased interest to the individual using the wireless communication device based on the weather-related information.

11. The method of claim 7, further comprising receiving a response from the wireless communications device and providing notification of the response to the advertiser sponsoring the transmitted advertisement.

12. The method of claim 7, wherein said message comprises one or more advertisements, promotions or electronic coupons.

13. The method of claim 7, wherein said message relates to a vendor.

14. The method of claim 13, wherein said message is prioritized for delivery based on said vendor's proximity to the mobile device.

15. The method of claim 13, wherein said message is prioritized for delivery based on said vendor's proximity to the mobile device rather then the highest bid for delivering the message.

16. The method of claim 7, wherein said detected location and weather-related information is real-time location-based information.

17. A computer based system for performing the method of claim 1, comprising one or more computer-based systems for delivering said messages and one or more mobile devices for receiving said messages.

18. A computer-based system for delivering one or more targeted messages to mobile devices comprising: a user interface for interacting with a first user; a network connection; a persistent storage; a memory for storing software instructions; and a processor operatively connected to the memory, the processor for executing the software instructions; wherein the software instructions enable the processor to: receive information relating to one or more mobile devices including location-based information and weather-based information; retrieve one or more targeted messages from the persistent storage selected based on said location-based information and said weather-based information; and transmit said targeted ads to said mobile devices.

19. A method for delivering a message to a mobile device, comprising:
(a) selecting one or more messages based on: (i) location-based information, advertiser GeoEstate rights and weather-related information relating to said mobile device's location; (ii) location-based information and advertiser GeoEstate rights; or (iii) advertiser GeoEstate rights and weather-related information; and
(b) transmitting said one or more messages to said mobile device.
